(19) United States
(12) Patent Application Publication
(10) Pub. No.: US 2019/0129918 A1
(43) Pub. Date: May 2, 2019

(54) METHOD AND APPARATUS FOR AUTOMATICALLY DETERMINING OPTIMAL STATISTICAL MODEL

(71) Applicant: SAMSUNG SDS CO., LTD., Seoul (KR)

(72) Inventors: Ki Hyo MOON, Seoul (KR); Sung Jun KIM, Seoul (KR); Hyun Bin LOH, Seoul (KR); Chan Koo LEE, Seoul (KR); Jin Hwan HAN, Seoul (KR)

(73) Assignee: SAMSUNG SDS CO., LTD., Seoul (KR)

(21) Appl. No.: 16/104,746

(22) Filed: Aug. 17, 2018

(30) Foreign Application Priority Data
Oct. 31, 2017 (KR) 10-2017-0144080

(51) Int. Cl. G06F 17/18

(52) U.S. Cl. CPC G06F 17/18

(57) ABSTRACT

A method of determining an optimal statistical model that can best show the statistical characteristics of given data and an apparatus performing the method are provided. The method acquires target data to be analyzed, where the target data consists of a plurality of independent variables and a dependent variable. Then, the method determines one or more independent variables based on variances in the target data, establishes a first statistical model that shows the relationship between the m independent variables and the dependent variable, and calculates first error of the first statistical model. The method generates a plurality of first statistical models by repeatedly performing the steps of establishing the first statistical model and calculating the first error while changing the value of m, and selects a statistical model with minimum error as an optimal statistical model for the target data. In this manner, a statistical model having the multi-collinearity between independent variables minimized and having an improved precision can be selected.

This application claims priority to Korean Patent Application No. 10-2017-0144080, filed on Oct. 31, 2017, and all the benefits accruing therefrom under 35 U.S.C. § 119, the disclosure of which is incorporated herein by reference in its entirety.

### BACKGROUND

### 1. Field

The present disclosure relates to a method and apparatus for automatically determining an optimal statistical model, and more particularly, to a method and apparatus for automatically determining an optimal statistical model that best shows the statistical characteristics of given data from among a variety of statistical model.

### 2. Description of the Related Art

Various statistical models are used to discover the statistical characteristics of a considerable amount of given data and to predict the future based on the discovered statistical characteristics.

A generalized linear model, which is a type of statistical model, is used to show the statistical characteristics of given data in various fields. The generalized linear model is an extended concept of a linear model and is a model capable of linearizing given data using a link function. Thus, in order to model given data using the generalized linear model, a dependent variable distribution type and a link function type of the generalized linear model need to be determined. Since the dependent variable distribution type and the link function type are main factors determining the statistical characteristics of given data, the accuracy of a statistical model is dependent upon selections of the dependent variable distribution type and the link function type.

Referring to FIG. 1, there are various types of dependent variable distributions (1) and various types of link functions (3) in the generalized linear model, and thus, multiple statistical models can be established based on combinations (5) of the dependent variable distributions (1) and the link functions (3). It is very difficult to choose an optimal dependent variable distribution type-link function type combination that best shows the statistical characteristics of given data.

Conventionally, a dependent variable distribution type and a link function type are determined based on the experience of experts in each field. However, this type of method has many problems. First, the accuracy of a statistical model may be considerably lowered if an incorrect dependent variable distribution type and an incorrect link function type are selected. Second, a determination can hardly be made as to whether each established statistical model is objectively optimal. Third, but not least, when there is the need to establish a new statistical model due to the imprecision of an existing statistical model, additional computing cost and time may be incurred.

Therefore, a method is needed to automatically determine an optimal statistical model for given data in accordance with an objective set of rules.

### SUMMARY

Exemplary embodiments of the present disclosure provide a method and apparatus for automatically determining an optimal statistical model.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to an exemplary embodiment of the present disclosure, there is provided a method of determining an optimal statistical mode, performed in an apparatus for determining an optimal statistical model, the method comprising a first step of acquiring target data to be analyzed, the target data consisting of a plurality of independent variables and a dependent variable, a second step of determining m independent variables (where m is a natural number of 1 or greater) based on variances in the target data, a third step of establishing a first statistical model showing a relationship between the m independent variables and the dependent variable and calculating first error of the first statistical model, a fourth step of generating a plurality of first statistical models by repeatedly performing the second and third steps while changing the value of m, and a fifth step of selecting an optimal statistical model for the target data from among the plurality of first statistical models based on the first error.

In some embodiments, the plurality of first statistical models are based on a generalized linear model, the third step comprises a first sub-step of the third step of determining a dependent variable distribution type and a link function type of the generalized linear model, a second sub-step of the third step of establishing a second statistical model having the determined dependent variable distribution type and the determined link function type, a third sub-step of the third step of calculating second error of the second statistical model through cross validation, and a fourth sub-step of the third step of generating a plurality of second statistical models by repeatedly performing the first, second, and third sub-steps of the third step while changing at least one of the dependent variable distribution type and the link function type, and the first statistical model is a statistical model selected from among the plurality of second statistical models based on the second error.

In some embodiments, the fourth step comprises repeatedly performing the second and third steps by reducing the value of m, and the second step comprises determining the m independent variables based on m top independent variables with largest variances.

In some embodiments, the target data includes training data and test data, and the third step comprises establishing the first statistical model using the training data and calculating third error of the first statistical model based on the training data, and calculating fourth error of the first statistical model by cross-validating the first statistical model using the test data.

In some embodiments, the fourth step comprises repeatedly performing the second and third steps until first error corresponding to local minima is detected, and the fifth step comprises selecting a first statistical model having error corresponding to the local minima from among the plurality of first statistical models as the optimal statistical model.

In some embodiments, the first error is calculated as relative error based on the size of input data used to calculate the first error.

According to an exemplary embodiment of the present disclosure, there is provided a method of determining an optimal statistical mode, performed in an apparatus for determining an optimal statistical model, the method comprising a first step of acquiring target data to be analyzed, the target data including training data and test data, a second step of establishing a plurality of statistical models using the training data, a third step of calculating first errors of the plurality of statistical models using the training data, a fourth step of calculating second errors of the plurality of statistical models using the training data, a fifth step of calculating final errors of the plurality of statistical models based on the first errors and the second errors, and a sixth step of selecting one of the plurality of statistical models as an optimal statistical model for the target data by comparing the final errors.

According to an exemplary embodiment of the present disclosure, there is provided an apparatus for determining an optimal statistical model, comprising a processor, a memory loading a computer program, which is executed by the processor, and a storage storing target data to be analyzed and the computer program, the target data including training data and test data, wherein the computer program comprises a first operation of establishing a plurality of statistical models using the training data, a second operation of calculating first errors of the plurality of statistical models using the training data, a third operation of calculating second errors of the plurality of statistical models using the training data, a fourth operation of calculating final errors of the plurality of statistical models based on the first errors and the second errors, and a fifth operation of selecting one of the plurality of statistical models as an optimal statistical model for the target data by comparing the final errors.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a schematic view illustrating various generalized linear models that can be established;

FIG. 2 is a schematic view illustrating the input and the output of an apparatus for determining an optimal statistical model according to an exemplary embodiment of the present disclosure;

FIG. 3 is a block diagram of the apparatus of FIG. 2;

FIG. 4 is a schematic view illustrating the hardware configuration of the apparatus of FIG. 3;

FIG. 5 is a schematic view illustrating a method of determining an optimal statistical model according to a first exemplary embodiment of the present disclosure;

FIG. 6 is a flowchart illustrating the method of determining an optimal statistical model according to the first exemplary embodiment of the present disclosure;

FIGS. 7A and 7B are schematic views illustrating methods of determining an independent variable according to exemplary embodiments of the present disclosure;

FIG. 8 is a detailed flowchart illustrating S140 of FIG. 6;

FIGS. 9A and 9B are schematic views illustrating methods of calculating error according to exemplary embodiments of the present disclosure;

FIG. 10 is a schematic view illustrating a method of determining an optimal statistical model according to a second exemplary embodiment of the present disclosure;

FIG. 11 is a flowchart illustrating the method of determining an optimal statistical model according to the second exemplary embodiment; and

FIG. 12 is a detailed flowchart illustrating S240 of FIG. 11.

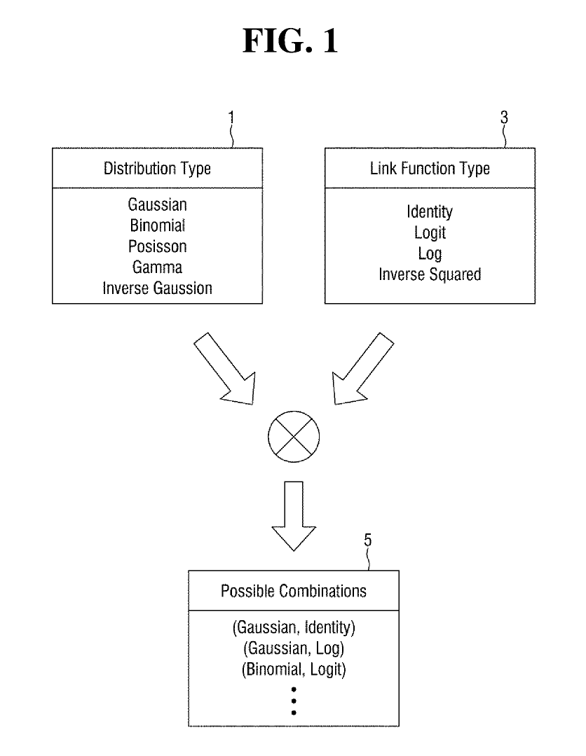

### DETAILED DESCRIPTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims. In the drawings, the size and relative sizes of layers and regions may be exaggerated for clarity. Like reference numerals refer to like elements throughout the specification. The terminology used herein is for the purpose of describing particular embodiments only and is not intended to be limiting of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the specification and will not be interpreted in an idealized or overly formal sense unless expressly so defined herein.

It will be further understood that the terms “comprises” and/or “comprising,” or “includes” and/or “including” when used in this specification, specify the presence of stated features, regions, integers, steps, operations, instructions, elements, components, and/or groups, but do not preclude the presence or addition of one or more other features, regions, integers, steps, operations, instructions, elements, components, and/or groups thereof.

Terms used in the present disclosure will hereinafter be clarified.

As used herein, the term “statistical model” encompasses nearly all types of models capable of representing the statistical characteristics of data. Examples of a statistical model include a linear model, a generalized linear model, and the like, but the present disclosure is not limited thereto.

Exemplary embodiments of the present disclosure will hereinafter be described with reference to the accompanying drawings.

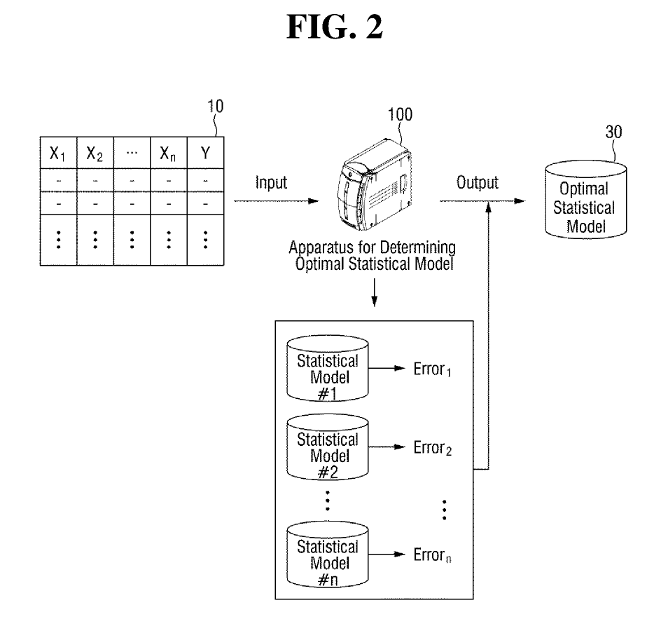

FIG. 2 is a schematic view illustrating the input and the output of an apparatus 100 for determining an optimal statistical model according to an exemplary embodiment of the present disclosure.

Referring to FIG. 2, the apparatus 100 is a computing device receiving target data 10 to be analyzed and outputting an optimal statistical model that best shows the statistical characteristics of the target data 10. Examples of the computing device include a notebook computer, a desktop computer, a laptop computer, and the like, but the present disclosure is not limited thereto. That is, examples of the computing device include nearly all types of devices equipped with a computing function. However, in case an optimal statistical model is established for a large amount of data, the apparatus 100 may preferably be implemented as a high-performance server computing device.

The apparatus 100 establishes a plurality of statistical models for the target data 10 and tests the established statistical models. In one example, a plurality of statistical models may be established by changing the number and the type of independent variables. In another example, a plurality of statistical models may be established by changing at least one of a dependent variable distribution type and a link function type. Table 1 below shows various types of dependent variable distributions and various types of link functions, and Table 2 further below shows exemplary statistical models that can be linearized in accordance with a generalized linear model.

TABLE 1

| Dependent Variable Distribution Type | | Link Function Type | |
|---|---|---|---|
| Gaussian | real (−∞, +∞) | Identity | f(x) = x |
| Binomial | integer {0, 1} | Logit | $f ( x ) = ln ( \frac{x}{1 - x} )$ |
| Poisson | integer {0, 1, 2, . . . } | Log | f(x) = ln(x) |
| Gamma | real (0 + ∞) | Inverse | $f ( x ) = \frac{1}{x}$ |
| Inverse Gaussian | real (0, +∞) | Inverse Squared | $f ( x ) = \frac{1}{{x}^{2}}$ |

TABLE 2
Statistical Model

| | |
|---|---|
| Gaussian | f(x) = x₁β₁ + . . . + xₘβₘ |
| Binomial | $f ( x ) = \frac{exp ( {x}_{1} {β}_{1} + … + {x}_{m} {β}_{m} )}{1 + exp ( {x}_{1} {β}_{1} + … + {x}_{m} {β}_{m} )}$ |
| Poisson | f(x) = exp(x₁β₁ + . . . + xₘβₘ) |
| Gamma | $f ( x ) = \frac{1}{{x}_{1} {β}_{1} + … + {x}_{m} {β}_{m}}$ |
| Inverse Gaussian | $f ( x ) = \frac{1}{\sqrt{{x}_{1} {β}_{1} + … + {x}_{m} {β}_{m}}}$ |

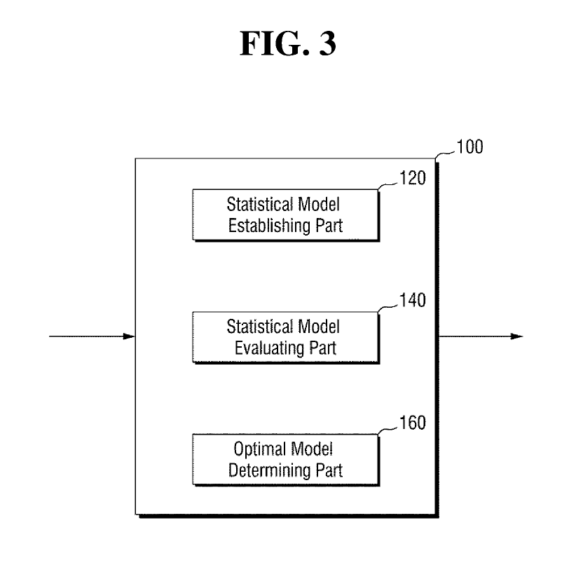

The apparatus 100 determines the optimal statistical model 30 for the target data 10 based on the result of the testing of the established statistical model. This will be described later with reference to FIG. 3.

The target data 10 may consist of a plurality of independent variables and a dependent variable. The independent variables are also referred to by various other names, such as explanatory variables, features, independent variables, predictor variables, or the like. The concepts of the independent variables and the dependent variable are already well known to one of ordinary skill in the art, and thus, detailed descriptions thereof will be omitted.

The optimal statistical model 30 is a statistical model that best shows the statistical characteristics of the target data 10. The optimal statistical model 30 may be used later to predict the characteristics of other data, indicated by the dependent variable.

Statistical models established by the apparatus 100 may be based on a generalized linear model, but the present disclosure is not limited thereto. That is, exemplary embodiments of the present invention that will hereinafter be described are also applicable to any arbitrary statistical models without making any modifications thereto.

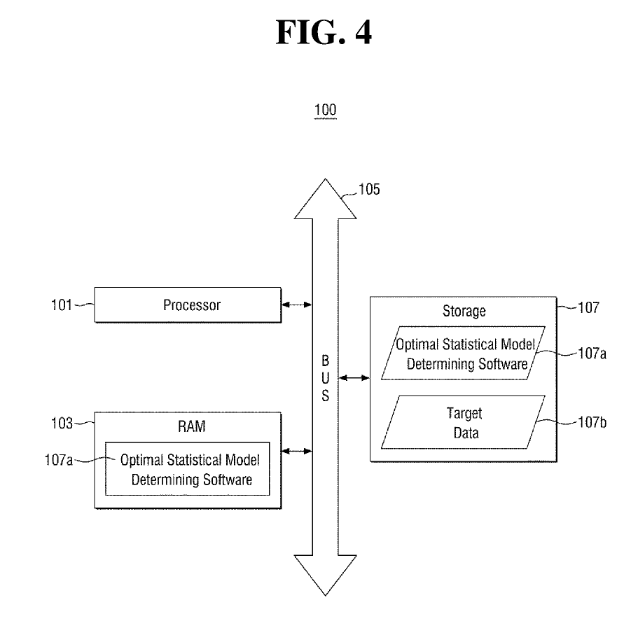

The structure and operations of the apparatus 100 will hereinafter be described with reference to FIGS. 3 and 4.

FIG. 3 is a block diagram of the apparatus 100.

Referring to FIG. 3, the apparatus 100 may include a statistical model establishing part 120, a statistical model evaluating part 140, and an optimal model determining part 160. FIG. 3 shows only the relevant parts to the inventive concept of the present disclosure. Thus, it is obvious that the apparatus 100 may further include general-purpose parts other than those illustrated in FIG. 3. Also, the elements of the apparatus 100, illustrated in FIG. 3, are functional elements that are functionally distinguishable from one another, and in an actual physical environment, the elements of the apparatus 100 may be incorporated into fewer elements.

The statistical model establishing part 120 determines m independent variables based on variances in target data to be analyzed and establishes a statistical model showing the relationship between the m independent variables and a dependent variable. The statistical model establishing part 120 may establish a plurality of statistical models by changing the value of m.

Alternatively, the statistical model establishing part 120 may establish a plurality of statistical models by changing at least one of a dependent variable distribution type and a link function type of a generalized linear model.

Alternatively, the statistical model establishing part 120 may establish a plurality of statistical models by changing the value of m and at least one of the dependent variable distribution type and the link function type.

The statistical model establishing part 120 may continue to establish a statistical model until an iteration terminating condition is met. For example, the detection of error corresponding to local minima, the detection of error corresponding to global minima, or a predetermined number of iterations may be set as the iteration terminating condition.

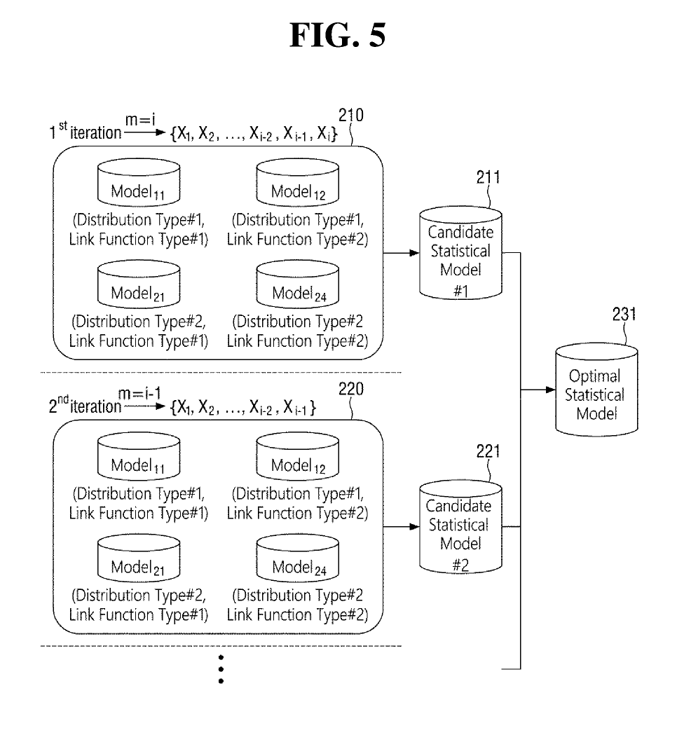

The establishing of a plurality of statistical models by the statistical model establishing part 120 using the iteration termination condition will be described later with reference to FIGS. 5 through 12.

The statistical model evaluating part 140 calculates error of each of the plurality of statistical models established by the statistical model establishing part 120. The calculation of error of a statistical model by the statistical model evaluating part 140 will be described later with reference to Equations 1 through 5.

The optimal model determining part 160 determines an optimal statistical model for the target data based on the result of the calculation performed by the statistical model evaluating part 140. Specifically, if the iteration termination condition is the detection of error corresponding to local minima, the optimal model determining part 160 determines a statistical model having error corresponding to local minima as the optimal statistical model. If the iteration termination condition is the detection of error corresponding to global minima, the optimal model determining part 160 determines a statistical model having error corresponding to global minima as the optimal statistical model. If the iteration termination condition is a predetermined number of iterations, the optimal model determining part 160 determines a statistical error with minimum error as the optimal statistical model.

The elements of the apparatus 100, illustrated in FIG. 3, may be, but are not limited to, software modules or may be hardware modules such as field programmable gate arrays (FPGAs) or application-specific integrated circuits (ASICs). The elements of the apparatus 100, illustrated in FIG. 3, may be configured to be stored in an addressable storage medium or to execute one or more processors. The functionalities provided by the elements of the apparatus 100, illustrated in FIG. 3, may be implemented by subdivided elements, or the elements of the apparatus 100, illustrated in FIG. 3, may be incorporated into fewer elements performing particular functions.

FIG. 4 is a schematic view illustrating the hardware configuration of the apparatus 100.

Referring to FIG. 4, the apparatus 100 may include at least one processor 101, a bus 105, a memory 103 loading therein a computer program executed by the processor 101, and a storage 107 storing optimal statistical model determining software 107a. It is obvious that the apparatus 100 may further include general-purpose parts other than those illustrated in FIG. 4, such as a network interface.

The processor 101 controls general operations of the elements of the apparatus 100. The processor 101 may be a central processing unit (CPU), a micro-processor unit (MPU), a micro-controller unit (MCU), a graphic processing unit (GPU), or an arbitrary processor that is already well known in the art. The processor 101 may operate at least one application or program for executing a method of determining an optimal statistical model according to some exemplary embodiments of the present disclosure. The apparatus 100 may include one or more processors 101.

The memory 103 stores various data, instructions and/or information. The memory 103 may load at least one program 107a from the storage 107 to execute the method of determining an optimal statistical model according to some exemplary embodiments of the present disclosure. FIG. 4 illustrates a random access memory (RAM) as an exemplary memory 103.

The bus 105 provides a communication function between the elements of the apparatus 100. The bus 105 may be implemented as an address bus, a data bus, a control bus, or the like.

The storage 107 may non-temporarily store the program 107a and target data 107b to be analyzed. FIG. 4 illustrates the optimal statistical model determining software 107a as an exemplary program 107a.

The storage 107 may be a nonvolatile memory such as a read only memory (ROM), an erasable programmable ROM (EPROM), an electrically erasable programmable ROM (EEPROM), or a flash memory, a hard disk, a removable disk, or an arbitrary computer-readable recording medium that is already well known in the art.

The optimal statistical model determining software 107a may be loaded in the memory 103 and may include operations for enabling the processor 101 to perform the method of determining an optimal statistical model according to some exemplary embodiments of the present disclosure.

In one example, the optimal statistical model determining software 107a may include a first operation of determining m independent variables (where m is a natural number of 1 or greater) based on variances in the target data 107b, a second operation of establishing a first statistical model showing the relationship between the m independent variables and a dependent variable and calculating first error of the first statistical model, a third operation of establishing a plurality of first statistical models by repeatedly performing the first and second operations while changing the value of m, and a fourth operation of choosing an optimal statistical model for the target data 107b from among the plurality of first statistical models obtained by the third operation based on the first error.

In another example, the optimal statistical model determining software 107a may include a first operation of establishing a plurality of statistical models using training data, a second operation of calculating first errors of the plurality of statistical models using the training data, a third operation of calculating second errors of the plurality of statistical models using test data, a fourth operation of calculating final errors of the plurality of statistical models based on the first errors and the second errors, and a fifth operation of choosing an optimal statistical model for the target data 107b from among the plurality of statistical models through a comparison of the final errors.

The structure and the operations of the apparatus 100 have been described above with reference to FIGS. 3 and 4. Hereinafter, a method of determining an optimal statistical model according to some exemplary embodiments of the present disclosure will be described with reference to FIGS. 5 through 12.

Steps of the method of determining an optimal statistical model according to some exemplary embodiments of the present disclosure may be performed by a computing device. For example, the computing device may be the apparatus 100. For convenience, the description of the subject of each of the steps of the method of determining an optimal statistical model according to some exemplary embodiments of the present disclosure may be omitted. The steps of the method of determining an optimal statistical model according to some exemplary embodiments of the present disclosure may be implemented as operations of a computer program executed by a processor.

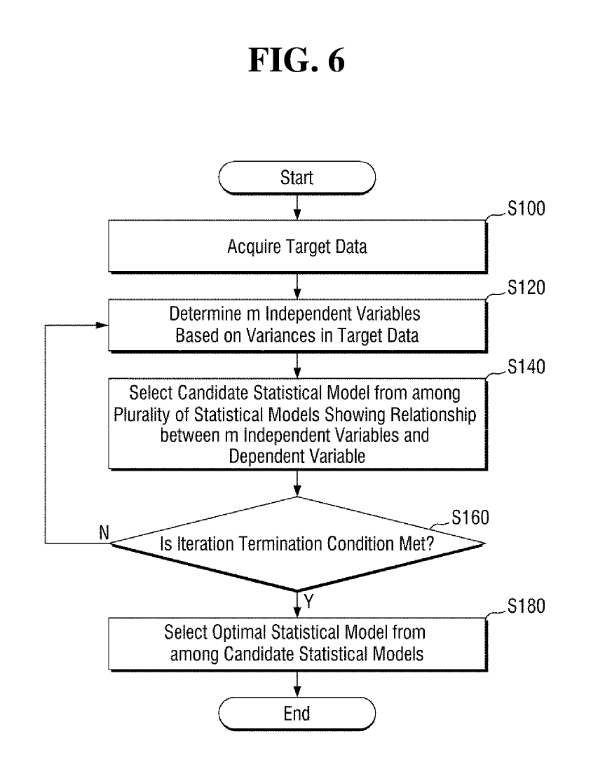

A method of determining an optimal statistical model according to a first exemplary embodiment of the present disclosure will hereinafter be described with reference to FIGS. 5 through 9B. The method of determining an optimal statistical model according to the first exemplary embodiment will hereinafter be described in general terms with reference to FIG. 5, and steps of the method of determining an optimal statistical model according to the first exemplary embodiment will be described later in detail with reference to FIGS. 6 through 9B.

Referring to FIG. 5, a plurality of groups of statistical models (210 and 220) are established by changing at least one of a dependent variable distribution type and a link function type while changing the number of independent variables. For example, in a first iteration, a plurality of first statistical models 210 are established using m independent variables, and in a second iteration, a plurality of second statistical models 220 are established using (m−1) independent variables. The first statistical models 210 show the relationship between the m independent variables and a dependent variable and differ from one another in at least one of the dependent variable distribution type and the link function type. The second statistical models 220 show the relationship between the (m−1) independent variables and the dependent variable and differ from one another in at least one of the dependent variable distribution type and the link function type

A plurality of candidate statistical models (211 and 221) that meet a predetermined condition are selected for the plurality of groups of statistical models (210 and 220). Specifically, a first candidate statistical model 211 is chosen for the first statistical models 210, and a second candidate statistical model 221 is chosen for the second statistical models 220.

An optimal statistical model 231 for target data to be analyzed is selected from between the plurality of candidate statistical models (211 and 221).

In short, a plurality of candidate statistical models are selected for a plurality of groups of statistical models that have the same independent variables but differ from one another in at least one of the dependent variable distribution type and the link function type, and one of the selected candidate statistical models is determined as an optimal statistical model. The method of determining an optimal statistical model according to the first exemplary embodiment will hereinafter be described in detail with reference to FIGS. 6 through 9B.

FIG. 6 is a flowchart illustrating the method of determining an optimal statistical model according to the first exemplary embodiment. The method of FIG. 6 is merely exemplary, and some steps may be newly added to, or deleted from, the method of FIG. 6.

Referring to FIG. 6, in S100, the apparatus 100 acquires target data to be analyzed. As already mentioned above, the target data includes a plurality of data consisting of a plurality of independent variables and a dependent variable.

In S120, the apparatus 100 determines m independent variables (where m is a natural number of 1 or greater) based on variances in the target data. The variances in the target data refer to variances in the distribution of the target data and may be measured using, for example, variation, standard deviation, or the like. The m independent variables may be understood as corresponding to principal component variables that can well represent the target data. Thus, in S120, the m independent variables are selected in the order of magnitude of variances.

In one exemplary embodiment, the m independent variables may be principal component variables obtained by principal component analysis. That is, the m independent variables may be m top principal component variables with largest variances among a number of principal component variables obtained by principal component analysis. Principal component analysis is already well known in the art, and thus, a detailed description thereof will be omitted. In this exemplary embodiment, m independent variables are generated by principal component analysis, and due to the characteristics of principal component analysis, the m independent variables have a low correlation with one another, but can well represent the distribution of the target data. Accordingly, multi-collinearity between independent variables can be minimized, and the precision of statistical models can be improved. Also, since data that forms each statistical model has a lower dimension than the target data, statistical models can be quickly established.

In another exemplary embodiment, the m independent variables may be independent variables selected from among the existing independent variables of the target data. In this exemplary embodiment, the variations or the standard deviations of the independent variables of the target data are calculated, and m top independent variables with largest variations or largest standard deviations are selected from among the independent variables of the target data. Even in this exemplary embodiment, some independent variables not corresponding to principal component variables can be excluded, and as a result, statistical models can be quickly and precisely established.

Before S120, independent variables of the target data that have no independent relation may be excluded. Specifically, the apparatus 100 may detect a first independent variable that is not in an independent relation from the independent variables of the target data and may exclude the detected first independent variable. Accordingly, the variances in the target data are calculated based only on all the independent variables of the target data except for the first independent variable. To determine whether a particular independent variable is in an independent relation, at least one well-known statistical algorithm may be used, and nearly any type of statistical algorithm may be used. Since unnecessary independent variables, such as redundant independent variables, can be eliminated from the target data, the target data can be refined, and statistical models can be quickly established.

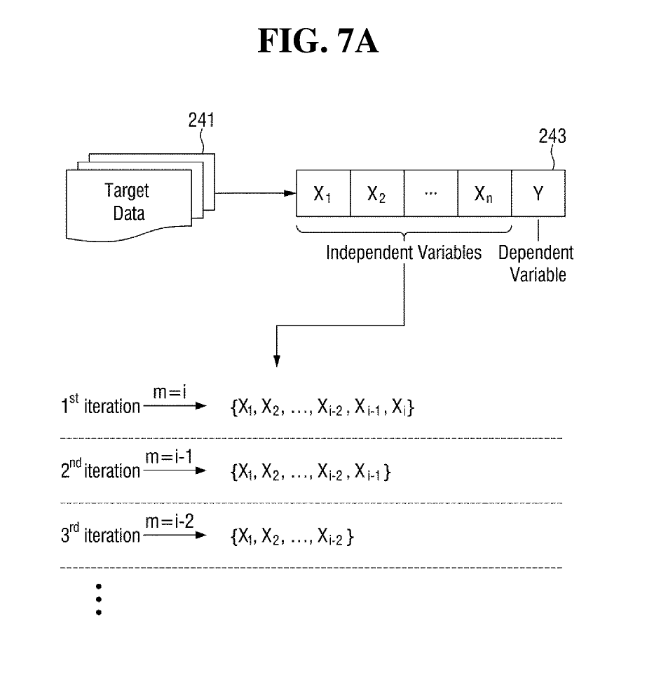

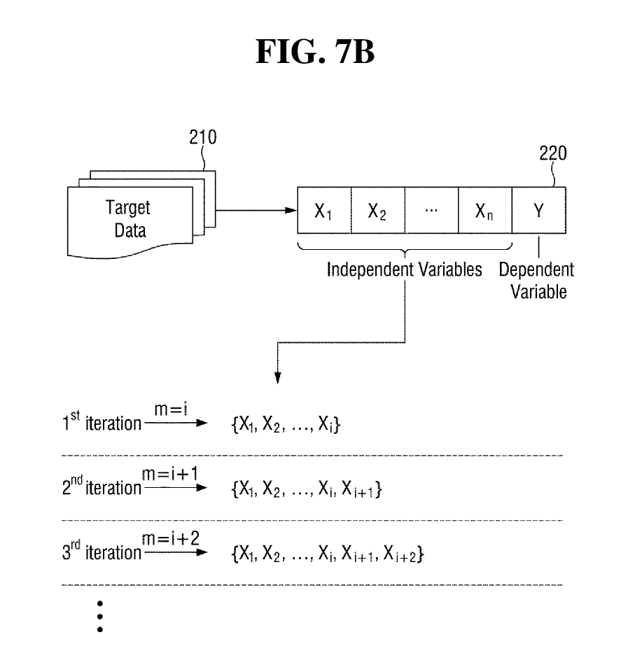

In S140, the apparatus 100 establishes a plurality of statistical models showing the relationship between the m independent variables and the dependent variable and selects a candidate statistical model from among the established statistical models. Specifically, the apparatus 100 establishes a plurality of statistical models showing the relationship between the m independent variables and the dependent variable by changing at least one of the dependent variable distribution type and the link function type. S140 will be described later with reference to FIG. 7.

In S160, the apparatus 100 determines whether an iteration termination condition is met, and in response to a determination being made that the iteration termination condition is not met, the apparatus 100 performs S120 and S140 again. In this case, the number of independent variables, i.e., the value of m, is changed whenever the apparatus 100 performs S120 and S140 again.

In one exemplary embodiment, the apparatus 100 may repeatedly perform S120 and S140 while lowering the value of m. This exemplary embodiment is as illustrated in FIG. 7A. Referring to FIG. 7A, the value of m is sequentially lowered for each iteration. Specifically, FIG. 7A shows an example in which the value of m is lowered by one for each iteration, but the amount by which the value of m is lowered for each iteration may vary. Alternatively, the amount by which the value of m is lowered for each iteration may be fixed or may vary depending on the circumstances. For example, as the computing performance of the apparatus 100 is higher, the amount by which the value of m is lowered for each iteration may become smaller.

In another exemplary embodiment, the apparatus 100 may repeatedly perform S120 and S140 while increasing the value of m. This exemplary embodiment is as illustrated in FIG. 7B. Referring to FIG. 7B, the value of m is sequentially increased for each iteration. Specifically, FIG. 7B shows an example in which the value of m is increased by one for each iteration, but the amount by which the value of m is increased for each iteration may vary. Alternatively, the amount by which the value of m is increased for each iteration may be fixed or may vary depending on the circumstances. For example, as the computing performance of the apparatus 100 is higher, the amount by which the value of m increases for each iteration may become smaller.

In yet another exemplary embodiment, the apparatus 100 may repeatedly perform S120 and S140 while randomly changing the value of m.

Referring again to FIG. 6, in S160, in response to a determination being made that the iteration termination condition is met, the apparatus 100 performs S180. The iteration termination condition may be set in various manners.

In one exemplary embodiment, the iteration termination condition may be the detection of error corresponding to local minima. To this end, the apparatus 100 may determine whether the error of each candidate statistical model corresponds to local minima. For example, if error continues to decrease until an i-th candidate statistical model selected in an i-th iteration is encountered and the error of an (i+1)-th candidate statistical model selected in an (i+1)-th iteration increases from the error of the i-th candidate statistical model, the apparatus 100 may determine the error of the i-th candidate statistical model as corresponding to local minima. Here, the local minima may be first local minima or may be n-th local minima (where n is a natural number of 2 or greater). In this exemplary embodiment, S160 is repeatedly performed until a candidate statistical model having error corresponding to local minima is detected. Thus, the amount of time and computing cost for determining an optimal statistical model can be considerably reduced.

In another exemplary embodiment, the iteration termination condition may be the detection of error corresponding to global minima. To detect error of global minima, all possible combinations of statistical models can be established. In this manner, a further optimal statistical model can be obtained, but this exemplary embodiment may be inefficient in terms of computing cost and time.

In yet another exemplary embodiment, the iteration termination condition may be set as a predetermined number of iterations. In yet still another exemplary embodiment, the iteration termination condition may be set as the combination of the predetermined number of iterations and the detection of error corresponding to local minima.

The iteration termination condition may be designated by a user or may be automatically designated by the apparatus 100. For example, the apparatus 100 may automatically designate the iteration termination condition based on at least one of the computing cost (or time) required to calculate error corresponding to global minima and the computing performance of the apparatus 100. In one example, since the greater the number of independent variables, the more the time (and the higher the computing cost) required for detecting error corresponding global minima, the apparatus 100 may determine the detection of error corresponding to local minima if the number of independent variables, i.e., the value of m, exceeds a threshold value, and may determine the detection of error corresponding to global minima otherwise. In another example, the apparatus 100 may determine the detection of error corresponding to global minima as the iteration termination condition if the computing performance of the apparatus 100 is excellent enough to meet a predetermined condition, and may determine the detection of error corresponding to local minima otherwise.

Finally, in S180, the apparatus 100 determines an optimal statistical model for the target data. Specifically, if the iteration termination condition is the detection of error corresponding to local minima, a candidate statistical model having error corresponding to local minima may be determined as the optimal statistical model. Similarly, if the iteration termination condition is the detection of error corresponding to global minima, a candidate statistical model having error corresponding to global minima may be determined as the optimal statistical model.

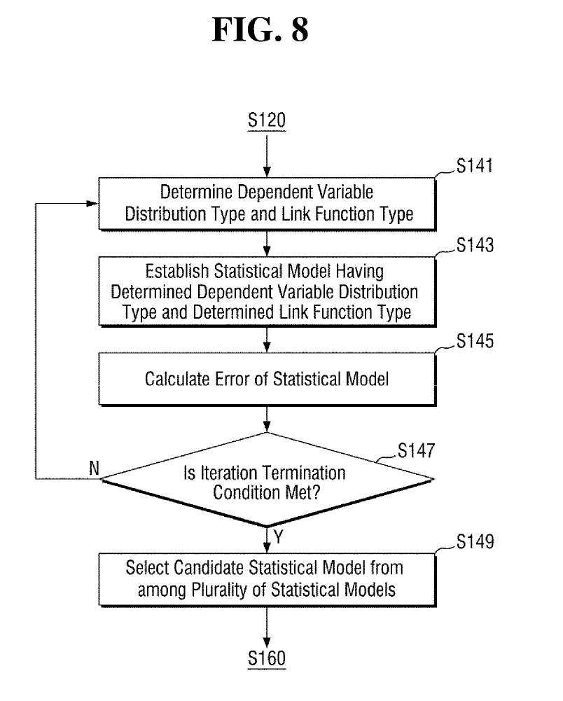

The selection of a candidate statistical model, i.e., S140, will hereinafter be described with reference to FIG. 8. FIG. 8 is a flowchart illustrating the establishing of a plurality of statistical models by changing at least one of a dependent variable distribution type and a link type function and the selection of a candidate statistical model from among the plurality of statistical models.

Referring to FIG. 8, in S141, the apparatus 100 determines a dependent variable distribution type and a link function type. Various types of dependent variable distributions and various types of link functions are as shown in Table 1 above.

In S143, the apparatus 100 establishes a statistical model having the determined dependent variable distribution type and the determined link type. Specifically, a statistical model may be established by learning a statistical model having the determined dependent variable distribution type and the determined link function type from the target data. The established statistical model shows the relationship between the m independent variables determined in S120 and the dependent variable and has the determined dependent variable distribution type and the determined link function type.

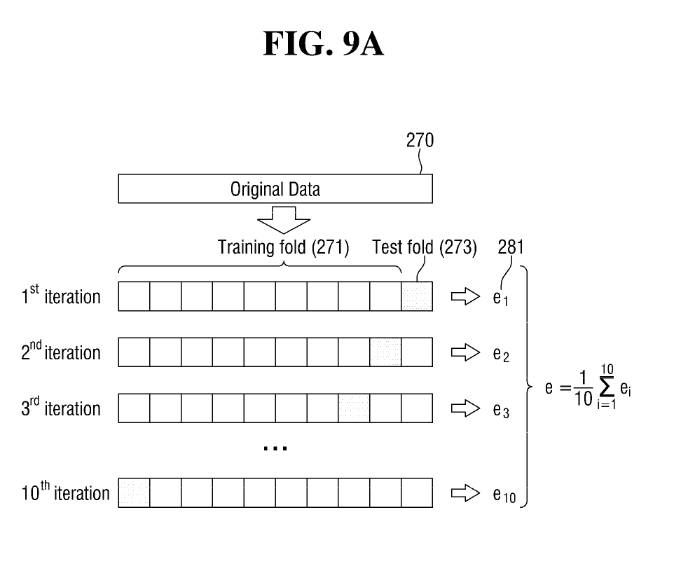

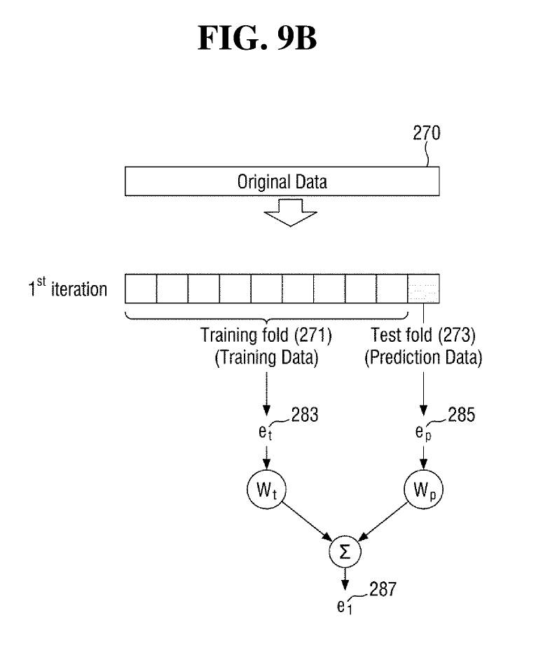

In S145, the apparatus 100 calculates error of the established statistical model. To calculate error of the established statistical model, a k-fold cross validation technique may be used. As shown in FIG. 9A, the k-fold cross validation technique divides original data 270 into a training fold 271 and a test fold 273 and validates a model learned from the training fold 271 with the test fold 273. This validation process may be performed k times. Specifically, FIG. 9A shows 10-fold cross validation. Cross validation is already well known in the art, and thus, a detailed description thereof will be omitted.

In one exemplary embodiment, prediction error, which is error calculated by cross validation, is determined as final error of the established statistical model.

In another exemplary embodiment, final error of the established statistical model may be determined based on both the prediction error and training error, which is error calculated from training data. This exemplary embodiment will hereinafter be described with reference to FIG. 9B. FIG. 9B shows an exemplary process of calculating final error in the first step of 10-fold cross validation. Referring to FIG. 9B, training error eₜ (283) is calculated from training data 271, and prediction error eₚ (285) is calculated from test data 273. Finally, in the first step of cross validation, the weighted sum of the training error eₜ and the prediction error eₚ may be determined as final error e₁.

To obtain final error e, a greater weighting may be applied to the prediction error eₚ than to the training error eₜ, as shown in Equation (1) below. Referring to Equation (1), e, eₜ, and eₚ denote final error, training error, and prediction error, respectively, and k denotes the value of k as in k-fold cross validation. As shown in Equation (1), a weighting of k−1/k is applied to the prediction error eₚ, and a weighting of 1/k is applied to the training error eₜ. Since two types of errors, i.e., the prediction error eₚ and the training error eₜ, are used and a greater weighting is applied to the prediction error eₚ than to the training error eₜ, the final error e can be precisely calculated, and as a result, an optimal statistical mode can be precisely determined.

$$e = \frac{{e}_{t} + ( k - 1 ) {e}_{p}}{k} . \qquad ( 1 )$$

Each error (e.g., training error and prediction error) may be calculated as relative error based on the size of input data. For example, if the established statistical model is a linear model following Equation (2) below, the training error eₜ may be calculated by Equation (4), and the prediction error eₚ may be calculated by Equation (5). Also, each of the statistical models shown in Table 2 can be linearized using any one of the link functions shown in Table 1, and the error of the corresponding statistical model can be calculated using Equation (1) above.

\tilde{x}=x₁β₁+ . . . +xₘβₘ (2)

where β₁ through βₘ denote coefficients of a linear model. Equation (2) is already well known in the art, and thus, a detailed description thereof will be omitted.

Equation (3) below is for calculating absolute training error based on the difference (or distance) between the output of a statistical model and training data. Referring to Equation (4) below, a value (xᵢ₁²+ . . . +xᵢₘ²) indicating the size of input data is in the denominator, and the training error eₜ may be calculated as a relative value to the value (xᵢ₁²+ . . . +xᵢₘ²). In Equation (4), N₁ denotes the number of training data. Equation (4) may be understood as being for obtaining average relative training error.

$$\begin{matrix}\vert \tilde{x} - {x}_{i} \vert = \frac{\vert {β}_{1} {x}_{i 1} + … + {β}_{m} {x}_{im} \vert}{\sqrt{{β}_{1}^{2} + … + {β}_{m}^{2}}} . & ( 3 ) \\ {e}_{t} = \frac{1}{{N}_{1}} {\sum }_{i = 1}^{i = {N}_{1}} \frac{\vert {β}_{1} {x}_{i 1} + … + {β}_{m} {x}_{im} \vert}{\sqrt{{β}_{1}^{2} + … + {β}_{m}^{2}} \sqrt{{x}_{i 1}^{2} + … + {x}_{im}^{2}}} . & ( 4 )\end{matrix}$$

Equation (5) below is for obtaining relative prediction error using the difference (or distance) between the output of a statistical model and test data. In Equation (5), N₂ denotes the number of test data, \tilde{y}ᵢ denotes the output of a statistical model, and yᵢ denotes i-th test data.

$${e}_{p} = \frac{1}{{N}_{2}} {\sum }_{i = 1}^{i = {N}_{2}} \vert \frac{{\tilde{y}}_{i} - {y}_{i}}{{y}_{i}} \vert . \qquad ( 5 )$$

Referring again to FIG. 8, in S147, the apparatus 100 determines whether an iteration termination condition is met. The detection of error corresponding to local minima, the detection of error corresponding to global minima, a predetermined number of iterations, or a combination thereof may be set as the iteration termination condition. The iteration termination condition of S147 may be set independently of the iteration termination condition of S160.

In S149, in response to a determination being made that the iteration termination condition is met, the apparatus 100 determines a candidate statistical model. Specifically, if the iteration termination condition is the detection of error corresponding to local minima, the apparatus 100 selects a statistical model having error (or final error) corresponding to local minima from among a plurality of statistical models as the candidate statistical model. If the iteration termination condition is the detection of error corresponding to global minima, the apparatus 100 selects a statistical model having error corresponding to global minima from among the plurality of statistical models as the candidate statistical model. If the iteration termination condition is a predetermined number of iterations, the apparatus 100 selects a statistical error with minimum error from among the plurality of statistical models as the candidate statistical model.

The method of determining an optimal statistical model according to the first exemplary embodiment has been described above with reference to FIGS. 5 through 9B. In the method of determining an optimal statistical model according to the first exemplary embodiment, independent variables indicating principal components are determined again before the establishing of statistical models. Thus, the computing cost and time for establishing statistical models can be reduced, and the precision of statistical models can be improved. Also, in the method of determining an optimal statistical model according to the first exemplary embodiment, a plurality of statistical models are established by changing the number of independent variables and changing at least one of a dependent variable distribution type and a link function type. Since the establishing of statistical models is continued until a statistical model having error corresponding to local minima is detected, the computing cost and time for determining an optimal statistical model can be considerably reduced. In addition, an optimal statistical model can be determined objectively based on calculated errors.

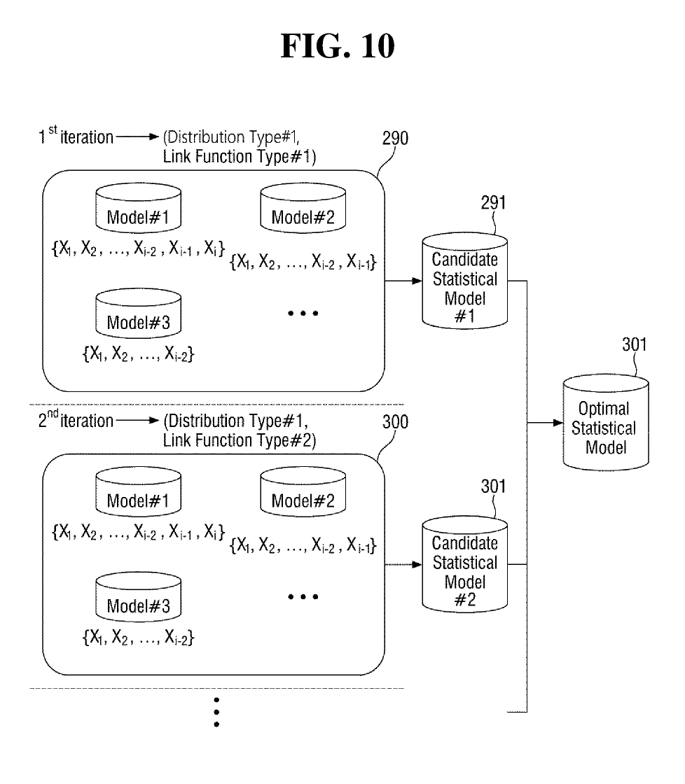

A method of determining an optimal statistical model according to a second exemplary embodiment of the present disclosure will hereinafter be described with reference to FIGS. 10 through 12. For convenience and clarity, descriptions of steps of the method of determining an optimal statistical model according to the second exemplary embodiment that are the same as, or similar to, their respective counterparts of the method of determining an optimal statistical model according to the first exemplary embodiment will be omitted.

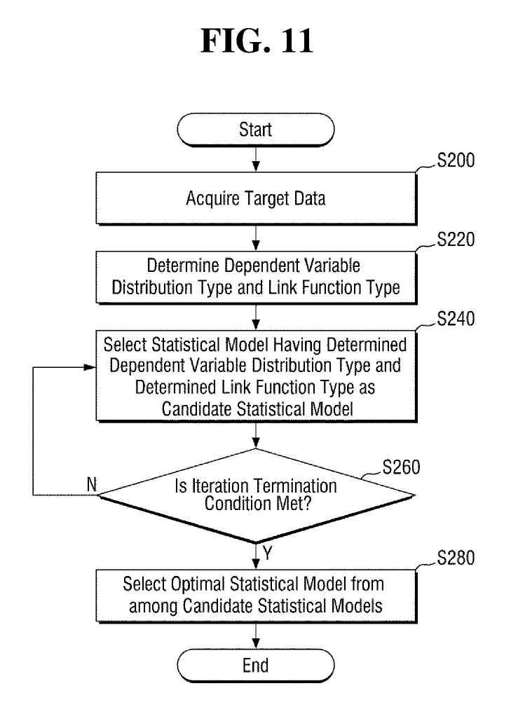

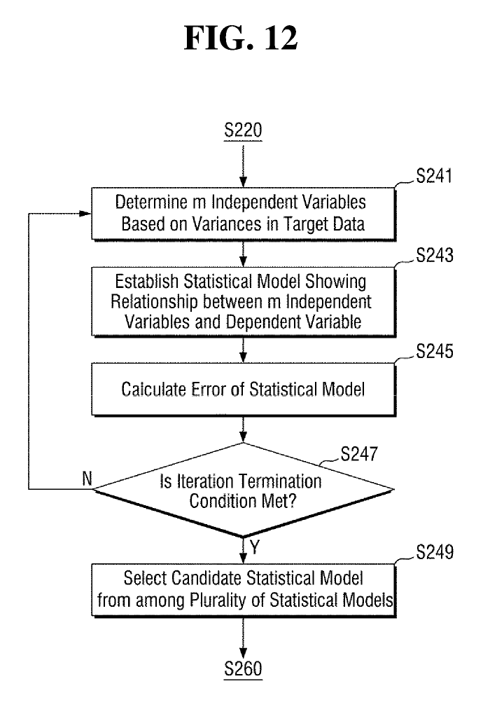

The method of determining an optimal statistical model according to the second exemplary embodiment will hereinafter be described in general terms with reference to FIG. 10, and steps of the method of determining an optimal statistical model according to the second exemplary embodiment will be described later in detail with reference to FIGS. 11 and 12.

Referring to FIG. 10, a plurality of candidate statistical models (291 and 301) are selected from among a plurality of groups of statistical models (290 and 300), and an optimal statistical model 301 is selected from among the plurality of candidate statistical models (291 and 301). In the second exemplary embodiment, unlike in the first exemplary embodiment, the plurality of groups of statistical models (290 and 300) are established based on the same dependent variable distribution type and the same link function type. Specifically, a first candidate statistical model 291 is selected from among a plurality of first statistical models 290 having the same dependent variable distribution type and the same link function type, and a second candidate statistical model 301 is selected from among a plurality of second statistical models 300 having the same dependent variable distribution type and the same link function type. The selection of the first and second candidate statistical models 291 and 301 is performed using a similar method to that used in the first exemplary embodiment.

The plurality of first statistical models 290 have the same dependent variable distribution type and the same link function type, and at least some of the plurality of first statistical models 290 have different combinations of independent variables from one another. A method used to determine independent variables in the second exemplary embodiment is similar to a method used to determine independent variables in the first exemplary embodiment. However, in the first exemplary embodiment, unlike in the second exemplary embodiment, the plurality of first statistical models 290 have the same combination of independent variables, but have different dependent variable distribution types and/or different link function types.

The method of determining an optimal statistical model according to the second exemplary embodiment will hereinafter be described in further detail.

FIG. 11 is a flowchart illustrating the method of determining an optimal statistical model according to the second exemplary embodiment. The method of FIG. 11 is merely exemplary, and some steps may be newly added to, or deleted from, the method of FIG. 11.

Referring to FIG. 11, in S200, the apparatus 100 acquires target data to be analyzed.

In S220, the apparatus 100 determines a dependent variable distribution type and a link function type. The dependent variable distribution type and the link function type are determined by selecting from among combinations of various types of dependent variable distributions and various types of link functions in any order such as sequential, reverse, or random order.

In S240, the apparatus 100 selects a candidate statistical model from among a plurality of statistical models having the determined dependent variable distribution type and the determined link function type. As mentioned above, the plurality of statistical models have the same dependent variable distribution type and the same link function type, and at least some of the plurality of statistical models may show the relationships between a dependent variable and different sets of independent variables. S240 will be described later with reference to FIG. 12.

In S260, the apparatus 100 determines whether an iteration termination condition is met. The iteration termination condition is as described above with regard to the first exemplary embodiment.

In S280, the apparatus 100 determines an optimal statistical model. Specifically, if the iteration termination condition is the detection of error corresponding to local minima, the apparatus 100 selects a candidate statistical model having error (e.g., final error) corresponding to local minima as the optimal statistical model. If the iteration termination condition is the detection of error corresponding to global minima, the apparatus 100 selects a candidate statistical model having error corresponding to global minima as the optimal statistical model. If the iteration termination condition is a predetermined number of iterations, the apparatus 100 selects a candidate statistical error with minimum error as the optimal statistical model.

S240 will hereinafter be described with reference to FIG. 12.

FIG. 12 is a detailed flowchart illustrating S240 of FIG. 11.

Referring to FIG. 12, in S241, the apparatus 100 determines m independent variables based on variances in target data to be analyzed. S241 is the same as its counterpart of the method of determining an optimal statistical model according to the first exemplary embodiment, and thus, a detailed description thereof will be omitted.

In S243, the apparatus 100 establishes a statistical model showing the relationship between the m independent variables and a dependent variable.

In S245, the apparatus 100 calculates error of the established statistical model. S245 is the same as its counterpart of the method of determining an optimal statistical model according to the first exemplary embodiment, and thus, a detailed description thereof will be omitted.

In S247, the apparatus determines whether an iteration termination condition is met. In response to a determination being made that the iteration termination condition is not met, S241, S243, and S245 are performed again, in which case, the number of independent variables, i.e., the value of m, may be changed. The change of the value of m is as described above with regard to the first exemplary embodiment.

In response to a determination being made that the iteration termination condition is met, the apparatus 100 selects a candidate statistical model from among a plurality of statistical models. Specifically, if the iteration termination condition is the detection of error corresponding to local minima, the apparatus 100 selects a statistical model having error corresponding to local minima as the candidate statistical model. If the iteration termination condition is the detection of error corresponding to global minima, the apparatus 100 selects a statistical model having error corresponding to global minima as the candidate statistical model. If the iteration termination condition is a predetermined number of iterations, the apparatus 100 selects a statistical error with minimum error as the candidate statistical model.

Exemplary embodiments of the present disclosure and the advantageous thereof have been described above with reference to FIGS. 2 through 12. However, the present disclosure is not limited thereto, and other features, aspects, and advantages of the subject matter of the present disclosure will become apparent from the drawings and the claims.

The methods according to the embodiment of the present invention may be performed by execution of a computer program implemented in the form of computer readable code on a computer readable medium. The computer readable medium may be any type of recording medium on which data that can be read by a computer system can be stored. Examples of the computer recordable medium include a read-only memory (ROM), a random access memory (RAM), a compact disc (CD)-ROM, a magnetic tape, a floppy disk, and an optical data storage device. The computer readable medium can also be distributed over network-coupled computer systems so that the computer readable code may be stored and executed in a distributed fashion.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the exemplary embodiments described above should not be understood as requiring such separation in all exemplary embodiments, and it should be understood that the described program components and systems can generally be integrated together in a single software product or packaged into multiple software products.

Exemplary embodiments of the present invention have been described with reference to the accompanying drawings. However, those skilled in the art will appreciate that various modifications, additions and/or substitutions are possible, without materially departing from the scope and spirit of the present invention. All such modifications are intended to be included within the scope of the present invention as defined by the following claims, with equivalents of the claims to be included therein. Although the present invention has been particularly shown and described with reference to exemplary embodiments thereof, it is to be understood that the foregoing is illustrative and is not to be construed as limiting the scope of the present invention.

What is claimed is:

1. A method of determining an optimal statistical model, performed by an apparatus for determining the optimal statistical model, the method comprising:
acquiring, via a processor of the apparatus, target data to be analyzed, the target data comprising a plurality of independent variables and a dependent variable;
determining m independent variables based on variances in the target data, wherein m is a natural number;
establishing a first statistical model representing a relationship between the m independent variables and the dependent variable and calculating a first error of the first statistical model;
generating a plurality of first statistical models by repeatedly performing the determining the m independent variables and the establishing the first statistical model while changing a value of m; and
selecting the optimal statistical model for the target data from among the plurality of first statistical models based on the first error.

2. The method of claim 1, wherein the acquiring the target data comprises detecting a first independent variable having no independent relation among the plurality of independent variables, excluding the first independent variable from the plurality of independent variables, and calculating the variances in the target data using other non-excluded independent variables from the plurality of independent variables.

3. The method of claim 2, further comprising:
determining whether a number of the other non-excluded independent variables exceeds a threshold value,
wherein the generating the plurality of first statistical models comprises:
based on a first determination that the number of the other non-excluded independent variables exceeds the threshold value, iteratively performing the determining the m independent variables and the establishing the first statistical model until the first error corresponding to local minima is detected, and
based on a second determination that the number of the other non-excluded independent variables does not exceed the threshold value, iteratively performing the determining the m independent variables and the establishing the first statistical model until the first error corresponding to global minima is detected, and
wherein the selecting the optimal statistical model for the target data comprises:
based on the first determination, selecting a statistical model having the first error corresponding to the local minima from among the plurality of first statistical models as the optimal statistical model, and
based on the second determination, selecting a statistical model having the first error corresponding to the global minima from among the plurality of first statistical models as the optimal statistical model.

4. The method of claim 1, wherein the plurality of first statistical models are based on a generalized linear model,
wherein the establishing the first statistical model comprises:
determining a dependent variable distribution type and a link function type of the generalized linear model,
establishing a second statistical model having the determined dependent variable distribution type and the determined link function type,
calculating a second error of the second statistical model through cross validation, and
generating a plurality of second statistical models by iteratively performing the determining the dependent variable distribution type and the link function type, the establishing the second statistical model, and the calculating the second error while changing at least one of the dependent variable distribution type and the link function type, and
wherein the first statistical model is selected from among the plurality of second statistical models based on the second error.

5. The method of claim 4, wherein the generating the plurality of second statistical models comprises iteratively performing the determining the dependent variable distribution type and the link function type, the establishing the second statistical model, and the calculating the second error until the second error corresponding to local minima is detected, and
wherein the first statistical model is the second statistical model having an error corresponding to the local minima, selected from among the plurality of second statistical models.

6. The method of claim 1, wherein the generating the plurality of first statistical models comprises iteratively performing the determining the m independent variables and the establishing the first statistical model by reducing the value of m, and
wherein the determining the m independent variables comprises determining the m independent variables based on m top independent variables with largest variances.

7. The method of claim 6, wherein the m independent variables are principal component variables obtained by a principal component analysis.

8. The method of claim 1, wherein the generating the plurality of first statistical models comprises iteratively performing the determining the m independent variables and the establishing the first statistical model by increasing the value of m, and
wherein the determining the m independent variables comprises determining the m independent variables based on m top independent variables with largest variances.

9. The method of claim 1, wherein the target data includes training data and test data, and
wherein the establishing the first statistical model comprises:
establishing the first statistical model using the training data,
calculating a third error of the first statistical model based on the training data, and
calculating a fourth error of the first statistical model by cross-validating the first statistical model using the test data.

10. The method of claim 9, wherein the first error is determined as a weighted sum of the third error and the fourth error by applying a greater weight to the fourth error than to the third error.

11. The method of claim 1, wherein the generating the plurality of first statistical models comprises iteratively performing the determining the m independent variables and the establishing the first statistical model until the first error corresponding to local minima is detected, and
wherein the selecting the optimal statistical model for the target data comprises selecting the first statistical model having the first error corresponding to the local minima from among the plurality of first statistical models as the optimal statistical model.

12. The method of claim 1, wherein the first error is calculated as a relative error with respect to a size of input data used to calculate the first error.

13. A method of determining an optimal statistical model, performed by an apparatus for determining the optimal statistical model, the method comprising:
acquiring, via a processor of the apparatus, target data to be analyzed, the target data including training data and test data;
establishing a plurality of statistical models using the training data;
calculating first errors of the plurality of statistical models using the training data;
calculating second errors of the plurality of statistical models using the training data;
calculating final errors of the plurality of statistical models based on the first errors and the second errors; and
selecting one of the plurality of statistical models as the optimal statistical model for the target data by comparing the final errors.

14. The method of claim 13, wherein the plurality of statistical models are based on a generalized linear model,
wherein the target data comprises a plurality of independent variables and a dependent variable,
wherein the establishing the plurality of statistical models comprises:
determining m independent variables based on variances in the target data, wherein m is a natural number,
establishing a statistical model showing a relationship between the m independent variables and the dependent variable, and
generating the plurality of statistical models by iteratively performing the determining the m independent variables and the establishing the statistical model while changing a value of m; and
wherein the selecting the one of the plurality of statistical models as the optimal statistical model comprises:
selecting, from among the plurality of statistical models, a candidate statistical model having a minimum final error,
obtaining multiple candidate statistical models by iteratively performing the establishing the plurality of statistical models, the calculating the first errors, the calculating the second errors, the calculating the final errors, and the selecting the candidate statistical model while changing at least one of a dependent variable distribution type and a link function type of the generalized linear model, and
selecting one of the multiple candidate statistical models as the optimal statistical model.

15. The method of claim 13, wherein the plurality of statistical models are based on a generalized linear model,
wherein the target data comprises a plurality of independent variables and a dependent variable,
wherein the establishing the plurality of statistical models comprises:
determining m independent variables based on variances in the target data, wherein m is a natural number, and
generating the plurality of statistical models, each showing a relationship between the m independent variables and the dependent variable, by changing at least one of a dependent variable distribution type and a link function type of the generalized linear model, and
wherein the selecting one of the plurality of statistical models as the optimal statistical model comprises:
selecting, from among the plurality of statistical models, a candidate statistical model having a minimum final error,
obtaining multiple candidate statistical models by iteratively performing the establishing the plurality of statistical models, the calculating the first errors, the calculating the second errors, the calculating the final errors, and the selecting the candidate statistical model while changing a value of m, and
selecting one of the multiple candidate statistical models as the optimal statistical model.

16. The method of claim 15, wherein the obtaining the multiple candidate statistical models comprises iteratively performing the establishing the plurality of statistical models, the calculating the first errors, the calculating the second errors, the calculating the final errors, and the selecting the candidate statistical model until a final error corresponding to local minima is detected, and
wherein a candidate statistical model having the final error corresponding to the local minima is selected from among the multiple candidate statistical models as the optimal statistical model.

17. The method of claim 13, wherein the final errors are determined as weighted sums of the first errors and the second errors by applying a greater weight to the second errors than to the first errors.

18. The method of claim 13, wherein the first errors and the second errors are calculated as relative errors with respect to a size of input data used to calculate the first errors and the second errors.

19. An apparatus for determining an optimal statistical model, the apparatus comprising:
a processor;
a memory loading a computer program, which is executed by the processor; and
a storage storing target data to be analyzed and the computer program, the target data including training data and test data,
wherein the computer program when, executed, by the processor, causes the processor to perform operations comprising:
establishing a plurality of statistical models using the training data,
calculating first errors of the plurality of statistical models using the training data,
calculating second errors of the plurality of statistical models using the training data,
calculating final errors of the plurality of statistical models based on the first errors and the second errors, and
selecting one of the plurality of statistical models as the optimal statistical model for the target data by comparing the final errors.

20. A method comprising:
acquiring, via a processor, target data to be analyzed, the target data comprising a plurality of independent variables and a dependent variable;
determining m independent variables based on variances in the target data, wherein m is a natural number;
establishing a first statistical model representing a first relationship between the m independent variables and the dependent variable and calculating a first error of the first statistical model, wherein the m independent variables of the first statistical model have first values;
establishing a second statistical model representing a second relationship between the m independent variables and the dependent variable and calculating a second error of the second statistical model, wherein the m independent variables of the second statistical model have second values;
selecting, as an optimal statistical model for the target data, one of the first statistical model and the second statistical model having a lowest error from among the first error and the second error.
